(19) United States
(12) Patent Application Publication
(10) Pub. No.: US 2005/0175311 A1
(43) Pub. Date: Aug. 11, 2005

(54) Systems and methods for fiber optic glass panel color and image display

(76) Inventor: Jonathan Eugene Brunson, Spring Lake, NC (US)

Correspondence Address: JONATHAN EUGENE BRUNSON, 204 DUNCAN ROAD, SPRING LAKE, NC, 28390, US

(21) Appl. No.: 10/775,970

(22) Filed: Feb. 11, 2004

(51) Int. Cl. G02B 6/00

(52) U.S. Cl. 385/147

(57) ABSTRACT

Provided herein the tools for assisting an individual operator in displaying images and colors by way of novelty fiber optic glass panels. An extension of these tools is the ability for the individual to project images and colors by way of adjusting the color and image frequencies. Specifically, through the use of, for example, fiber optic panels that are produced when oxygenated metallic salts react to form fused metallic oxides, and/or other chemicals, which are fashioned into very thin fiber optic panels. This process allows the fiber optic panels to function as lighting and display devices i.e., television, computer, camouflaging and lighting. Ultimately, these fiber optic panels are illuminated using a light source from which an image or color is projected inside the fiber optic panel causing an image or color to appear via a frequency interface. The fiber optic panel can be made commercially available to individuals' operating computers, televisions, automobiles, aircrafts, boats, cloaking and camouflaging devices, or located inside building structures. The intensity and frequency of the image/color is projected inside the panel causing an image/color to be controlled by way of a frequency interface that leads and renders objects visible or invisible to an observer. An individual, upon entering an automobile, boat, or building structure could select a specific color frequency and the light source would communicate the intensity of the light signals for colors displayed inside the fiber optic glass panels. Alternatively, an individual operating a computer, television, aircraft, boat, camouflaging and/or cloaking device could select a specific image frequency and the light source would communicate the intensity of the light signals for images/colors displayed inside the fiber optic glass panels.

### BACKGROUND OF THE INVENTION

1. Field of the Invention

This Invention relates to fiber optic systems for projecting colors and images. In particular, this invention relates to an individuals ability to select a specific color and/or image frequency to determine the color(s) and image(s) displayed [on] inside the fiber optic glass panel.

2. Background of the Invention

Controlling the frequencies interface can be achieved in various ways. For example, an individual using the image frequency interface can surf television or computer using fiber optic glass panels, or can camouflage and/or cloak an aircraft sheeted with fiber optic glass panels by projecting color, still and/or real-time images produced from image source.

Alternatively, an individual using the color frequency interface can color or cloak an automobile, boat, or building interior/exterior and windows sheeted with fiber optic glass panels by projecting colors, still and/or real-time images produced from the image source.

### SUMMARY OF THE INVENTION

While existing systems and methods work well in general, they have a number of shortcomings. For example, often an individual may not have immediate access to financial resources to purchase a computer and television monitor, and/or similar display device. Similarly, an individual may not wish to absorb the headache and cost of ordering and installing factory-tinted windows, or even risk the aftereffects associated with plastic widow tint such as the tint becoming bubbled, scratched, faded and/or peeled over time.

The systems and methods of this invention provide tools for assisting an individual operator in displaying images and colors by way of novelty fiber optic glass panels. An extension of these tools is the ability for the individual to project images and colors by way of adjusting the color and image frequencies. Specifically, through the use of, for example, fiber optic panels that are produced when oxygenated metallic salts react to form fused metallic oxides, and/or other chemicals, which are fashioned into very thin fiber optic panels. This process allows the fiber optic panels to function as lighting and display devices i.e., television, computer, and lighting. Ultimately, these fiber optic panels are illuminated using a light source from which an image or color is projected inside the fiber optic panel causing an image or color to appear via a frequency interface. The fiber optic panel can be made available to individuals' operating computers, televisions, automobiles, aircrafts, boats, cloaking and camouflaging devices, or located inside building structures. The intensity and frequency of the image/color is projected inside the panel causing an image/color to be controlled by way of a frequency interface that leads and renders objects visible or invisible to an observer. An individual, upon entering an automobile, boat, or building structure could select a specific color frequency and the light source would communicate the intensity of the light signals for colors displayed [on] inside the fiber optic glass panels. Alternatively, an individual operating a computer, television, aircraft, boat, camouflaging and/or cloaking device could select a specific image frequency and the light source would communicate the intensity of the light signals for images/colors displayed inside the fiber optic glass panels.

These and other features and advantages of this invention are described in or are apparent from the following detailed description of the embodiments.

### BRIEF DESCRIPTION OF THE DRAWINGS

The embodiments of the invention will be described in detail with reference to the following figures wherein:

FIG. 1 is a functional block diagram illustrating exemplary fiber optic system according to this invention;

FIG. 2 is a functional block diagram illustrating exemplary fiber optic system according to this invention;

FIG. 3 is a functional block diagram illustrating exemplary fiber optic system according to this invention;

### DETAILED DESCRIPTION OF THE INVENTION

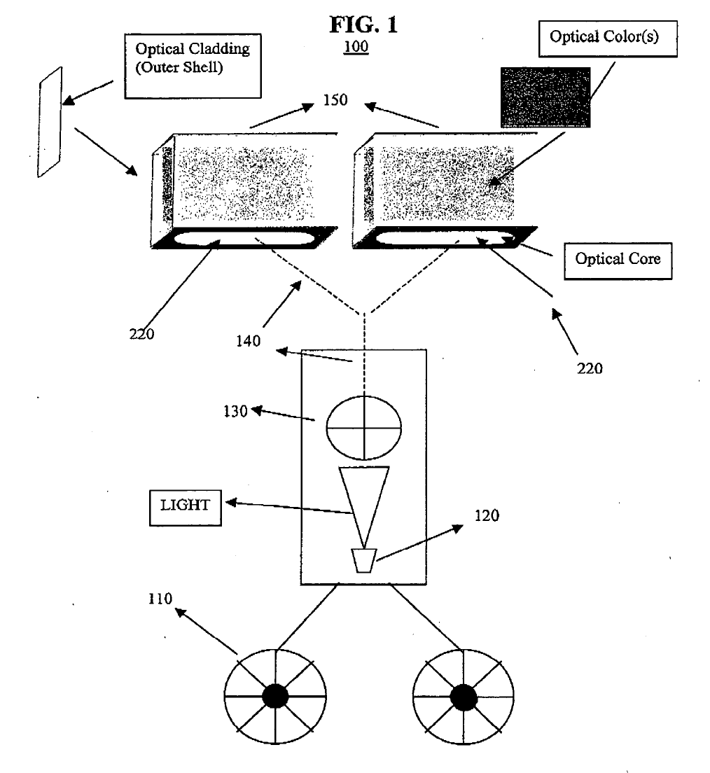

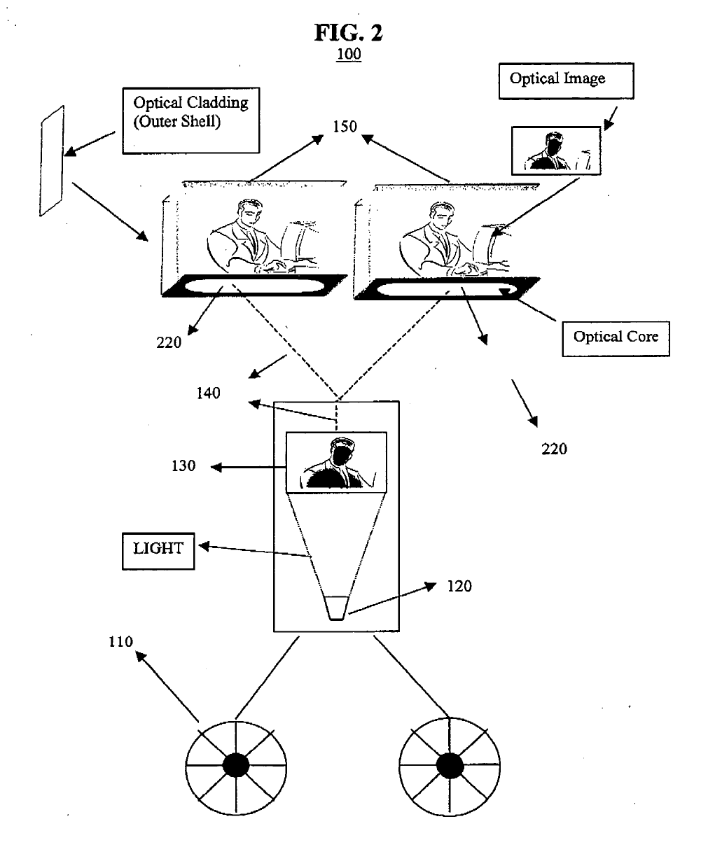

FIGS. 1 and 2 illustrates an exemplary fiber optic system according to an exemplary embodiment of the invention. Specifically, the fiber optic system 100 comprises a frequency interface 110, a light source 120, a color and/or image source 130, fiber optic strands 140, optical lens 220, and fiber optic glass panels 150, all interconnected.

The fiber optic system 100 comprises a frequency interface 110.

The light source 120 is connected to the color/image source 130, which is connecting the fiber optic strands 140, connecting the fiber optic glass panels 150.

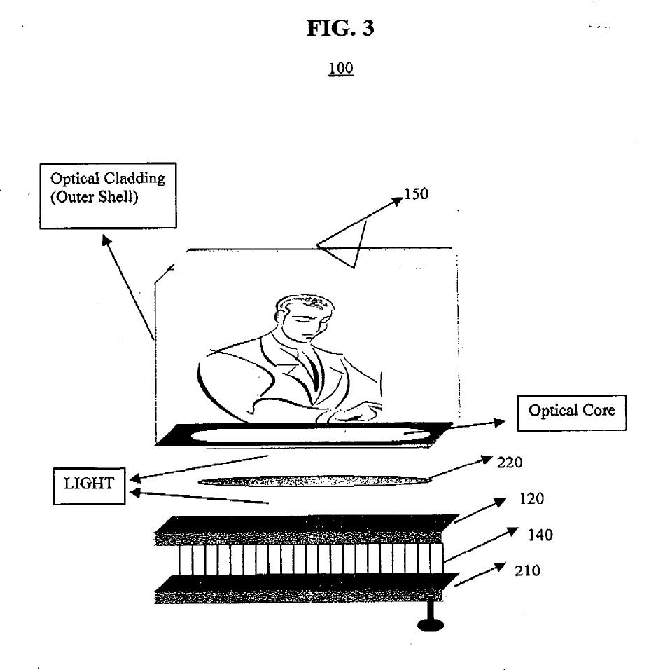

FIG. 3, however, illustrates an exemplary fiber optic system according to an exemplary embodiment of the invention. Specifically, the fiber optic system 100 comprises a receiver, encoder/decoder, computer processor, storage, and battery source 210, a light source 120, optical lens 220, fiber optic strands 140, and fiber optic glass panels 150, all interconnected.

Furthermore, the links 140 can be a wired or wireless link or any other known or later developed element(s) that is capable of supplying and communicating electronic data to and from the connected elements. For example, the links 5 can be optical links and communications between the various components based on, for example, a wireless or wire line network protocol.

In operation, the system is initialized, for example, by a user approaching the frequency interface 110 and requesting specific color or image frequency. For example, an individual, upon entering an automobile, boat, or building structure could select a specific color frequency and the light source 120 would communicate the intensity of the light signals for colors displayed on fiber optic glass panels 150.

Alternatively, an individual operating a computer, television, aircraft, boat, camouflaging and/or cloaking device could select a specific image frequency and the light source 120 would communicate the intensity of the light signals for images displayed on fiber optic glass panels 150.

Thus, the fiber optic system, upon receipt of a frequency request, forwards the request, via one or more fiber optic strands 140 to one or more fiber optic glass panels 150. The fiber optic glass panels 150 are then illuminated via the light source 120 to produce a color or image effect according to the requested frequency of the user.

As shown in FIG. 3, the fiber optic system can be implemented either on a single program general purpose computer, or a separate programmed general purpose computer. However, the fiber optic system can also be implemented on a special purpose computer, a programmed microprocess or micro controller and peripheral integrated circuit element, an ASIC or other integrated circuit, a digital signal processor, a hard wired electronic or logic circuit such as a discrete element circuit, a programmable logic device such as a PLD, PLA, FPGA, PAL, or the like. In general, any device capable of implementing a finite state machine that is in turn capable of being used to implement the fiber optic system according to this invention.

Furthermore, the disclosed method may be readily implemented using software development environments that provide portable source code that can be used on a variety of computer or workstation hardware platforms. Alternatively, the disclosed fiber optic system can be implemented partially or fully in hardware using standard logic circuit or VLSI design. Whether software or hardware is used to implement the systems in accordance with this invention, is dependent on the speed and/or efficiency requirements of the system, the particular function, and the particular software or hardware systems or microprocessor or microcomputer systems being utilized. The fiber optic system and methods illustrated herein however, can be readily implemented in hardware and/or software using any known or later developed systems or structures, devices and/or software by those of ordinary skill in the applicable art from the functional description provided herein and with the general basic knowledge of the computer, television, and telecommunications arts.

It is, therefore, apparent that there has been provided, in accordance with the present invention, systems and methods for fiber optic color and image display. While this invention has been described in conjunction with a number of embodiments, it is evident that many alternatives, modifications and variations would be or are apparent to those of ordinary skill in the applicable arts. Accordingly, it is the intent to embrace all such alternatives, modifications, equivalents and variations that are within the spirit and scope of this invention.

1. A fiber optic system comprising:
fiber optic glass panels;
a color frequency interface that allows an individual to select a specific color frequency and the color source would project the intensity of the light signal to determine the color(s) displayed inside the fiber optic glass panel(s) of an automobile, boat, building structure, or the like; and
an image frequency interface that allows an individual to select a specific image frequency and the image source would communicate the intensity of the light signal to determine the image(s) displayed inside the fiber optic glass panel(s) of an automobile, computer, television, boat, aircraft, camouflaging and/or cloaking device, or the like.

2. The system of claim 1, wherein the color/image frequencies interface is connecting a light source.

3. The system of claim 2, wherein the light source is connecting a color and/or image source.

4. The system of claim 3, wherein the color and/or image source is connecting fiber optic strands.

5. The system of claim 4, wherein the fiber optic strand(s) are connecting an optical lens for expanding the colors or images inside the fiber optic glass panels.

6. A method of producing fiber optic light signals comprising:
fiber optic glass panels;
a color frequency interface that allows an individual to select a specific color frequency and the color source would project the intensity of the light signal to determine the color(s) displayed inside the fiber optic glass panel(s) of an automobile, boat, building structure, or the like; and
an image frequency interface that allows an individual to select a specific image frequency and the image source would communicate the intensity of the light signal to determine the image(s) displayed inside the fiber optic glass panel(s) of an automobile, computer, television, boat, aircraft, camouflaging and/or cloaking device, or the like.

7. The method of claim 6, wherein the color/image frequencies interface is connecting a light source.

8. The method of claim 7, wherein the light source is connecting a color and/or image source.

9. The method of claim 8, wherein the color and/or image source is connecting fiber optic stands.

10. The method of claim 9, wherein the fiber optic stand(s) are connecting an optical lens for expanding the colors or images inside the fiber optic glass panels.

11. A method of producing fiber optic colors and images comprising:
fiber optic glass panels;
a color frequency interface that allows an individual to select a specific color frequency and the color source would project the intensity of the light signal to determine the color(s) displayed inside the fiber optic glass panel(s) of a computer or television display devices, or the like; and
an image frequency interface that allows an individual to select a specific image frequency and the image source would communicate the intensity of the light signal to determine the image(s) displayed inside the fiber optic glass panel(s) of an automobile, computer, television, boat, aircraft, camouflaging and/or cloaking device, or the like.

12. The method of claim 11, wherein the color/image frequencies interface is connecting a light source.

13. The method of claim 12, wherein the light source is connecting a color and/or image source.

14. The method of claim 13, wherein the color and/or image source is connecting fiber optic strands.

15. The method of claim 14, wherein the fiber optic strand(s) are connecting an optical lens for expanding the colors or images inside the fiber optic glass panels.

16. A system of displaying television and computer signals comprising:
fiber optic glass panels;
a color frequency interface that allows an individual to select a specific color frequency and the color source would project the intensity of the light signal to determine the color(s) displayed inside the fiber optic glass panel(s) of an automobile, boat, building structure, or the like; and
an image frequency interface that allows an individual to select a specific image frequency and the image source would communicate the intensity of the light signal to determine the image(s) displayed inside the fiber optic glass panel(s) of an automobile, computer, television, boat, aircraft, camouflaging and/or cloaking device, or the like.

17. The system of claim 16, wherein the color/image frequencies interface is connecting a light source.

18. The system of claim 17, wherein the light source is connecting color and/or image source.

19. The system of claim 18, wherein the color and/or image source is connecting fiber optic strands.

20. The system of claim 19, wherein the fiber optic strand(s) are connecting an optical lens for expanding the colors or images within inside the fiber optic glass panels.
